(19) United States
(12) Patent Application Publication
(10) Pub. No.: US 2004/0071496 A1
(43) Pub. Date: Apr. 15, 2004

(54) Pipe connecting structure for trampoline frame

(75) Inventor: Wang Lo Chun Yueh, Taipei (TW)

Correspondence Address: TROXELL LAW OFFICE PLLC, SUITE 1404, 5205 LEESBURG PIKE, FALLS CHURCH, VA, 22041, US

(73) Assignee: Shen-Tai Industry Co., Ltd.

(21) Appl. No.: 10/269,867

(22) Filed: Oct. 15, 2002

(51) Int. Cl. B25G 3/00

(52) U.S. Cl. 403/14

(57) ABSTRACT

A pipe connecting structure for trampoline frame includes a first pipe, a second pipe, and a coupling bar. The first pipe is provided at an end with a diameter-reduced portion having two diametrically opposite slots. The coupling bar is press-fitted in the diameter-reduced portion of the first pipe with an axial opening formed at its outer end in alignment with the two diametrically opposite slots on the first pipe. The second pipe is provided near an end for connecting to the diameter-reduced portion of the first pipe with a radially extended fixing pin. When the second pipe is connected to the diameter-reduced portion of the first pipe, the radial fixing pin is located in the two slots of the first pipe and the axial opening of the coupling bar to prevent the two pipes from circumferential movement relative to each other.

### BACKGROUND OF THE INVENTION

The present invention relates to a pipe connecting structure for trampoline frame, and more particularly to a pipe connecting structure that ensures firm and reliable connection of pipes for forming a trampoline frame.

A trampoline basically includes a frame and an elastic jumping bed tightly stretched over the frame. A player may jump on the jumping bed to show various movements. To allow the tightly stretched jumping bed to elastically deform within a sufficient space when a player jumps thereon, it is usually supported at a desired height via legs below the trampoline frame.

The jumping bed usually has a considerably large area and therefore necessitates a thick and long frame. It is difficult to produce such long frame with one single continuous pipe. In stead, the long frame must be formed by connecting multiple pipes one by one.

FIGS. 1 to 3 shows a conventional pipe connecting structure for trampoline frame. Pipes 10 and 20 represent two pipes that are to be connected to form a part of a trampoline frame. The pipe 10 is provided at a connecting end with a diameter-reduced portion 11, on which two diametrically opposite recesses 13 are punched to axially extend from an outmost edge of the connecting end by a predetermined distance. The pipe 20 is radially inward punched at a connecting end to form two diametrically opposite axial rails 22 corresponding to the two recesses 13. By engaging the pipe 20 with the diameter-reduced portion 11 of the pipe 10 with the rails 22 located in the recesses 13, the two pipes 10, 20 are connected to avoid circumferentially moving relative to each other.

The above-described conventional pipe connecting structure allows the two pipes 10, 20 to connect to each other only through engagement of the recesses 13 with the rails 22. Since the pipes 10, 20 have a limited wall thickness, the punched recesses 13 and rails 22 can have only limited depth, too, and do not provide sufficient and stable binding force to the pipes 10, 20. That is, the described conventional pipe connecting structure does not provide sufficient circumferential torsional resistance when it is employed on the trampoline frame that is frequently subjected to non-directional torsion.

### SUMMARY OF THE INVENTION

It is therefore a primary object of the present invention to provide an improved pipe connecting structure for trampoline frame that enables two adjacent pipes for a trampoline frame to firmly connect together without circumferentially moving relative to each other.

To achieve the above and other objects, the pipe connecting structure for trampoline frame according to the present invention mainly includes a first pipe, a second pipe, and a coupling bar. The first pipe is provided at an end with a diameter-reduced portion having two diametrically opposite slots. The coupling bar is press-fitted in the diameter-reduced portion of the first pipe with an axial opening formed at its outer end in alignment with the two diametrically opposite slots on the first pipe. The second pipe is provided near an end for connecting to the diameter-reduced portion of the first pipe with a radially extended fixing pin. When the second pipe is connected to the diameter-reduced portion of the first pipe, the radial fixing pin is located in the two slots of the first pipe and the axial opening of the coupling bar to prevent the two pipes from circumferential movement relative to each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a conventional pipe connecting structure for trampoline frame;

FIG. 2 is a sectional view of FIG. 1;

FIG. 3 is an assembled view of FIG. 2;

FIG. 4 is an assembled perspective view showing a pipe connecting structure for trampoline frame according to a preferred embodiment of the present invention;

FIG. 5 is an exploded perspective view of FIG. 4;

FIG. 6 is a partially assembled perspective view of FIG. 5 with a coupling bar already inserted into one of two pipes to be connected;

FIG. 7 is a sectional view of FIG. 6;

FIG. 8 is a sectional view of FIG. 4; and

FIG. 9 shows the pipe connecting structure of the present invention used on a trampoline frame.

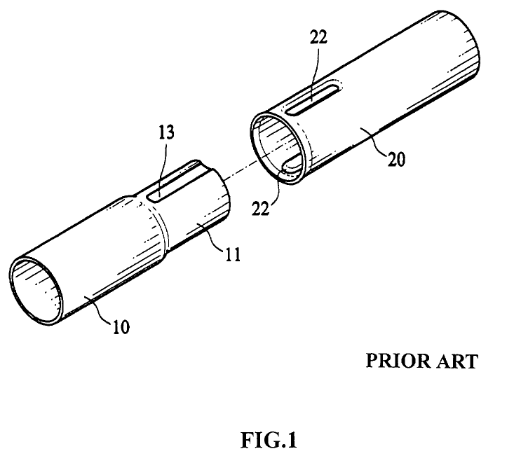

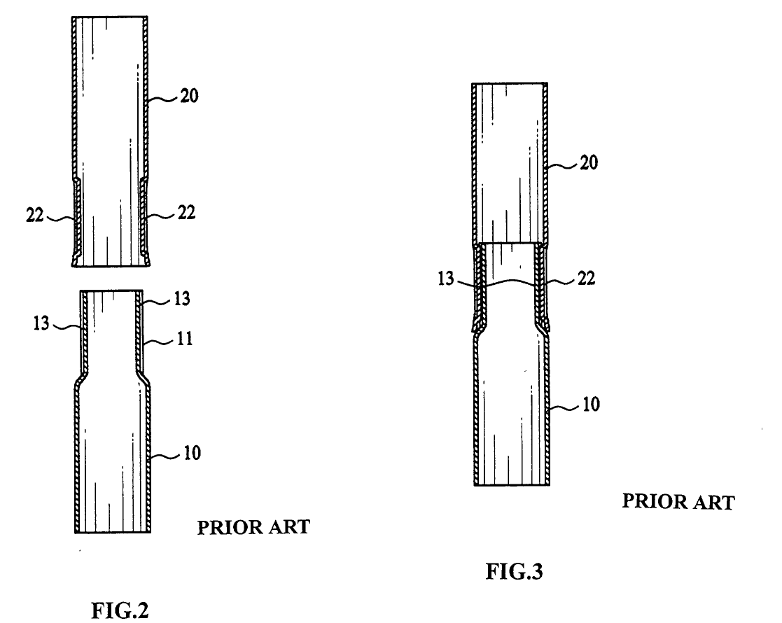

### DETAILED DESCRIPTION OF THE PREFERRED EMBODIMENTS

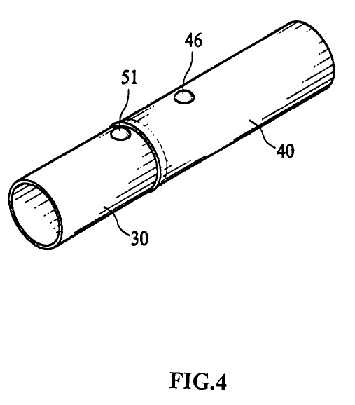

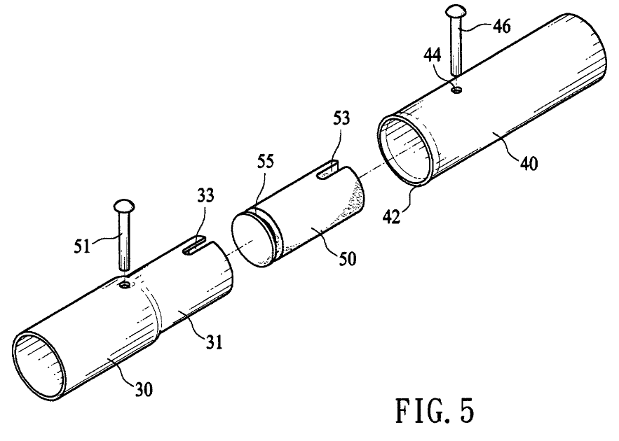

Please refer to FIGS. 4 and 5 that are assembled and exploded perspective views, respectively, of a pipe connecting structure for trampoline frame according to a preferred embodiment of the present invention. As shown, the pipe connecting structure is designed for connecting two opposite pipes, namely, a first pipe 30 and a second pipe 40, via a coupling bar 50.

An end of the first pipe 30 to be connected to the second pipe 40 is provided with a predetermined length of diameter-reduced portion 31, at an outmost end of which two diametrically opposite slots 33 are formed.

The coupling bar 50 is dimensioned for press fit in the diameter-reduced portion 31 of the pipe 30, and is provided at an outer end with an axially extended opening 53 corresponding to the slots 33 on the pipe 30. In the illustrated preferred embodiment of the present invention, the coupling bar 50 is provided near an inner end with an annular neck portion 55. A through hole is provided on the coupling bar 50 at the neck portion 55 to extend in the same plane passing the opening 53. When the coupling bar 50 is inserted into the diameter-reduced portion 31 of the pipe 30 with the opening 53 aligned with the slots 33, a first fixing pin 51 is inserted from outside of the pipe 30 via a hole formed thereon into the through hole at the neck portion 55 of the coupling bar 50 to hold the latter to the pipe 30.

The second pipe 40 is provided at a position close to an end 42 for connecting to the first pipe 30 with a locating hole 44, via which a second fixing pin 46 is inserted into the pipe 40 to function as a radial locating pin.

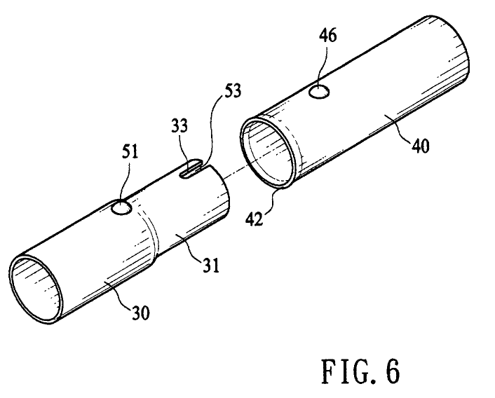

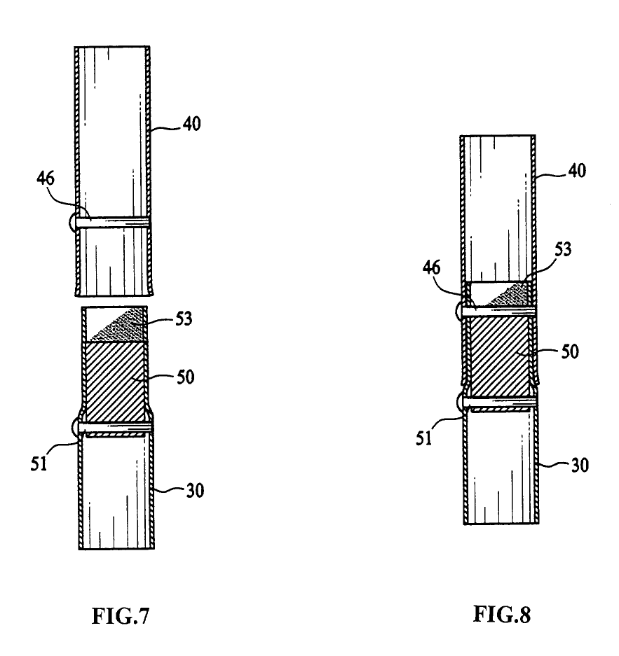

To connect the two pipes 30, 40 together, first insert the coupling bar 50 into the first pipe 30 in the manner described above, as shown in FIGS. 6 and 7, and then align the second fixing pin 46, that has already been inserted into the locating hole 44 on the second pipe 40, with the slots 33 and the opening 53 on the first pipe 30. At this point, the end 42 of the second pipe 40 can be easily fitted onto the diameter-reduced portion 31 of the first pipe 30 with the second fixing pin 46 located in the slots 33 and the opening 53, as shown in FIGS. 4 and 8. The two pipes 30, 40 are therefore connected to each other.

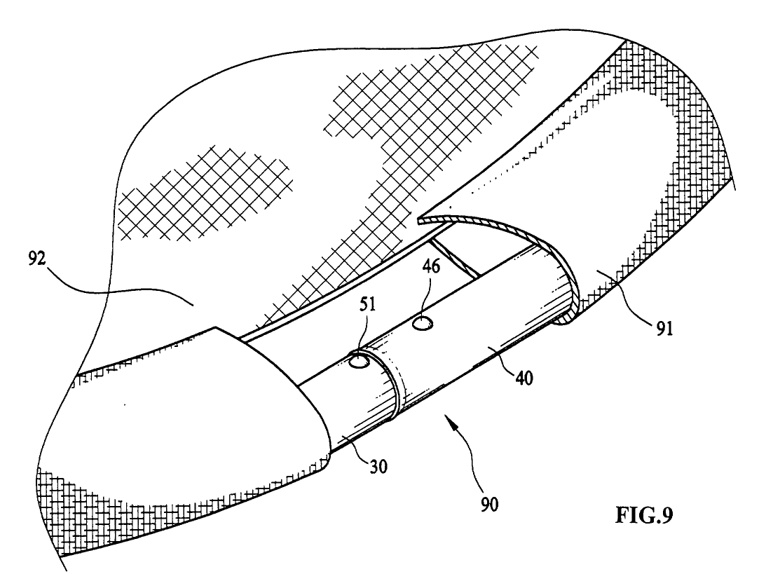

Please refer to FIG. 9. After a plurality of pipes provided with the pipe connecting structure of the present invention are sequentially connected to complete a trampoline frame 90, an elastic jumping bed 92 may be connected to an inner side of the frame 90 via protective links 91 that may be suitably located outside joints of pipes 30, 40 formed from the pipe connecting structure of the present invention. The pipes 30, 40 may be formed into desired curvatures for the trampoline frame 90 to have desired curve at desired positions.

Since the second fixing pin 46 of the second pipe 40 is radially received in the mutually aligned slots 33 and opening 53, it not only ensures firm and secure connection of the two pipes 30, 40 to each other, but also provides good circumferential locating power to protect the trampoline frame 90 assembled from multiple pipes 30, 40 from undesired vibration and structural damage due to non-directional torsion acted thereon.

The present invention has been described with a preferred embodiment thereof and it is understood that many changes and modifications in the described embodiment can be carried out without departing from the scope and the spirit of the invention as defined by the appended claims.

What is claimed is:

1. A pipe connecting structure for trampoline frame, comprising a first pipe, a second pipe, and a coupling bar;
said first pipe being provided at an end to be connected to said second pipe with a predetermined length of diameter-reduced portion, and at an outmost end of said diameter-reduced portion with two diametrically opposite slots;
said coupling bar being press-fitted in said diameter-reduced portion of said first pipe, and being provided at an outer end with an axially extended opening corresponding to said diametrically opposite slots on said first pipe; and
said second pipe being provided at a position close to an end for connecting to said first pipe with a locating hole via which a fixing pin is radially inserted into said second pipe;
whereby when said coupling bar is inserted into said diameter-reduced portion of said first pipe with said axially extended opening of said coupling bar aligned with said diametrically opposite slots of said first pipe, said second pipe can be connected to said diameter-reduced portion of said first pipe with said fixing pin located in said mutually aligned slots and opening, preventing said first and said second pipes from circumferentially moving relative to each other.

2. The pipe connecting structure for trampoline frame as claimed in claim 1, wherein said coupling bar is provided near an inner end with an annular neck portion, at where a radial hole is formed in the same plane passing said axially extended opening at the outer end of said coupling bar, and a fixing pin being inserted via a hole on said first pipe into said radial hole for holding said coupling bar to said first pipe.

3. The pipe connecting structure for trampoline frame as claimed in claim 1, wherein said fixing pin on said second pipe is radially extended from outside of said second pipe into said second pipe to function as a radial locating pin.
